(19) United States
(12) Patent Application Publication
(10) Pub. No.: US 2026/0279083 A1
(43) Pub. Date: Sep. 17, 2026

(54) ELECTRONIC DEVICE, METHOD, AND NON-TRANSITORY COMPUTER-READABLE RECORDING MEDIUM FOR ASSIGNING TAG TO CONTENT

(71) Applicant: Samsung Electronics Co., Ltd., Suwon-si (KR)

(72) Inventors: Subin LEE, Suwon-si (KR); Jaeyung YEO, Suwon-si (KR); Huncheol OH, Suwon-si (KR); Seonmin AHN, Suwon-si (KR); Miyeoung CHUNG, Suwon-si (KR)

(21) Appl. No.: 19/684,258

(22) Filed: May 21, 2026

Related U.S. Application Data
(63) Continuation of application No. PCT/KR2024/018788, filed on Nov. 25, 2024.

(30) Foreign Application Priority Data
Jan. 16, 2024 (KR) 10-2024-0007066
Mar. 4, 2024 (KR) 10-2024-0030976

(51) Int. Cl. G06V 20/70; G06V 10/74

(52) U.S. Cl. CPC G06V 20/70; G06V 10/761

(57) ABSTRACT

A method performed by electronic device is provided. The method includes identifying, by the electronic device, one or more first images to which a tag defined by a user input is assigned, based on a characteristic of the one or more first images, displaying, by the electronic device through the display, a plurality of second images among a plurality of images, and assigning, by the electronic device, the tag to the one or more first images and at least one third image selected by another user input among the plurality of second images.

### CROSS-REFERENCE TO RELATED APPLICATION(S)

This application is a continuation application, claiming priority under 35 U.S.C. § 365(c), of an International application No. PCT/KR2024/018788, filed on November 25, 2024, which is based on and claims the benefit of a Korean patent application number 10-2024-0007066, filed on January 16, 2024, in the Ministry of Intellectual Property (MOIP), and of a Korean patent application number 10-2024-0030976, filed on March 04, 2024, the disclosure of each of which is incorporated by reference herein in its entirety.

### BACKGROUND

### 1. Field

The disclosure relates to an electronic device, a method, and a non-transitory computer readable recording medium for assigning a tag to content.

### 2. Description of Related Art

A user may generate or collect various contents through an electronic device. Accordingly, the electronic device may store a plurality of contents. According to this use, the electronic device needs to manage the contents through technology for classifying or grouping the contents.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device, a method, and a non-transitory computer readable recording medium for assigning a tag to content.

Additional aspects will be set forth in part in the description which follows and, in part, will be apparent from the description, or may be learned by practice of the presented embodiments.

In accordance with an aspect of the disclosure, an electronic device is provided. The electronic device includes a display, memory, comprising one or more storage media, storing instructions, and at least one processor including processing circuitry communicatively coupled to the display and the memory, wherein the instructions, when executed by the at least one processor individually or collectively, cause the electronic device to identify one or more first images for assigning a tag defined by a user input, based on a characteristic of the one or more first images, display, through the display, a plurality of second images among a plurality of images, and assign the tag to the one or more first images and at least one third image selected by another user input among the plurality of second images.

In accordance with another aspect of the disclosure, a method performed by an electronic device is provided. The method includes identifying, by the electronic device, one or more first images for assigning a tag defined by a user input, based on a characteristic of the one or more first images, displaying, by the electronic device through the display, a plurality of second images among a plurality of images, and assigning, by the electronic device, the tag to the one or more first images and at least one third image selected by another user input among the plurality of second images.

In accordance with another aspect of the disclosure, one or more non-transitory computer readable storage media storing one or more computer programs including computer-executable instructions that, when executed by at least one processor including processing circuitry of an electronic device including a display, individually or collectively, cause the electronic device to perform operations are provided. The operations include identifying one or more first images for assigning a tag defined by a user input, based on a characteristic of the one or more first images, displaying, by the electronic device through the display, a plurality of second images among a plurality of images, and assigning the tag to the one or more first images and at least one third image selected by another user input among the plurality of second images.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A is a block diagram of an electronic device according to an embodiment of the disclosure;

FIG. 2B is a block diagram of a program of an electronic device according to an embodiment of the disclosure;

FIG. 3 is a graph illustrating an association between objects according to an embodiment of the disclosure;

FIG. 4A is a diagram illustrating an example of a screen of an electronic device according to an embodiment of the disclosure;

FIG. 4B is a diagram illustrating an example of a screen of an electronic device according to an embodiment of the disclosure;

FIG. 5 is a diagram illustrating an example of a screen of an electronic device according to an embodiment of the disclosure;

FIG. 6A is a diagram illustrating an example of a screen of an electronic device according to an embodiment of the disclosure;

FIG. 6B is a diagram illustrating an example of a screen of an electronic device according to an embodiment of the disclosure;

FIG. 6C is a diagram illustrating an example of a screen of an electronic device according to an embodiment of the disclosure;

FIG. 6D is a diagram illustrating an example of a screen of an electronic device according to an embodiment of the disclosure;

FIG. 7A is a diagram illustrating an example of a screen of an electronic device according to an embodiment of the disclosure;

FIG. 7B is a diagram illustrating an example of a screen of an electronic device according to an embodiment of the disclosure;

FIG. 8 is a flowchart illustrating an operation of an electronic device according to an embodiment of the disclosure; and

FIG. 9 is a flowchart illustrating an operation of an electronic device according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

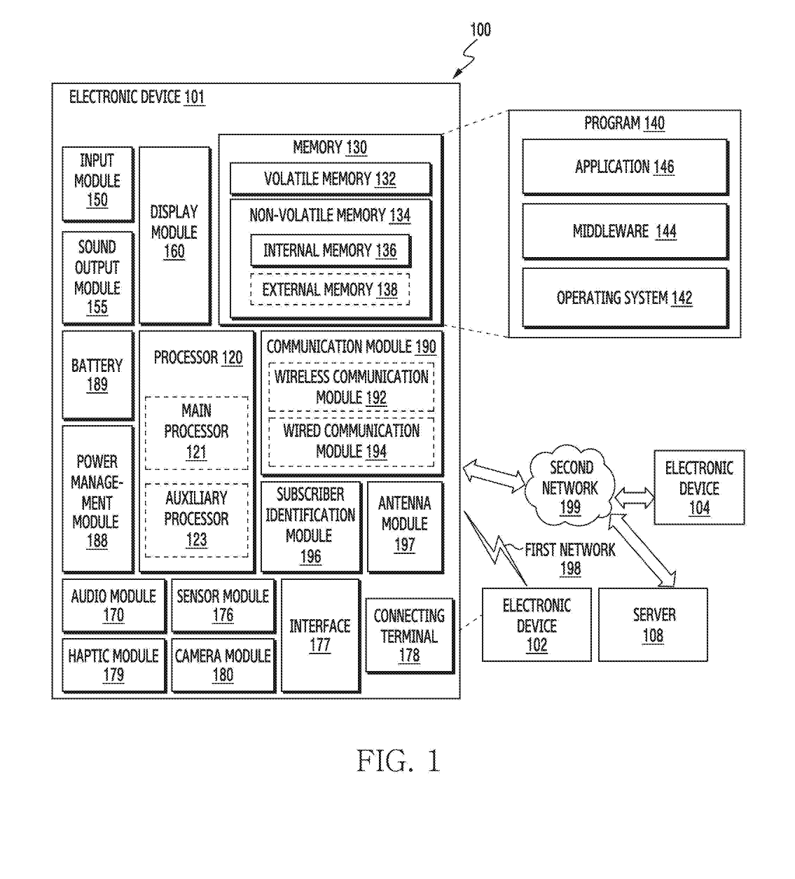

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

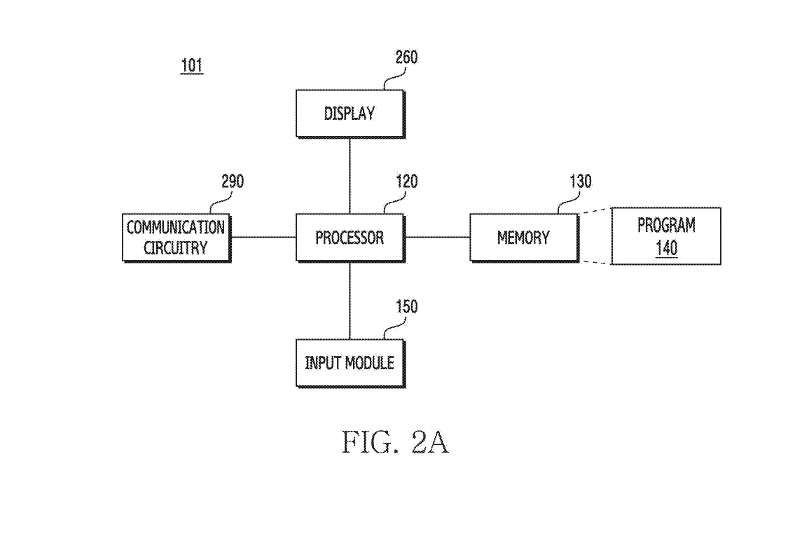

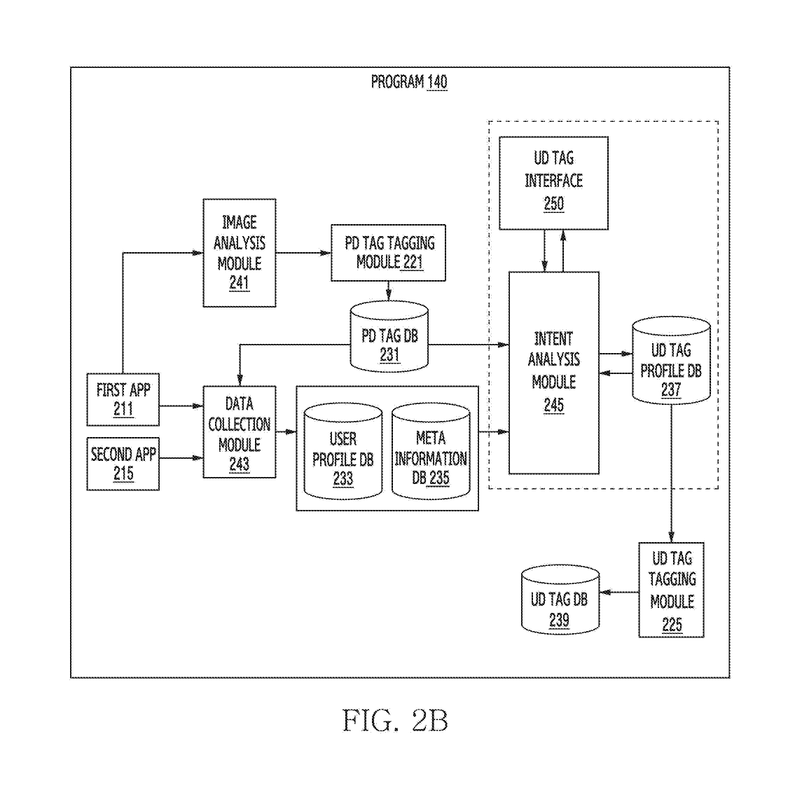

FIG. 2A is a block diagram of an electronic device according to an embodiment of the disclosure.

In an embodiment, an electronic device 101 of FIG. 2A may correspond to the electronic device 101 of FIG. 1. Referring to FIG. 2A, the electronic device 101 may include a processor 120, memory 130, an input module 150, a display 260, and communication circuitry 290.

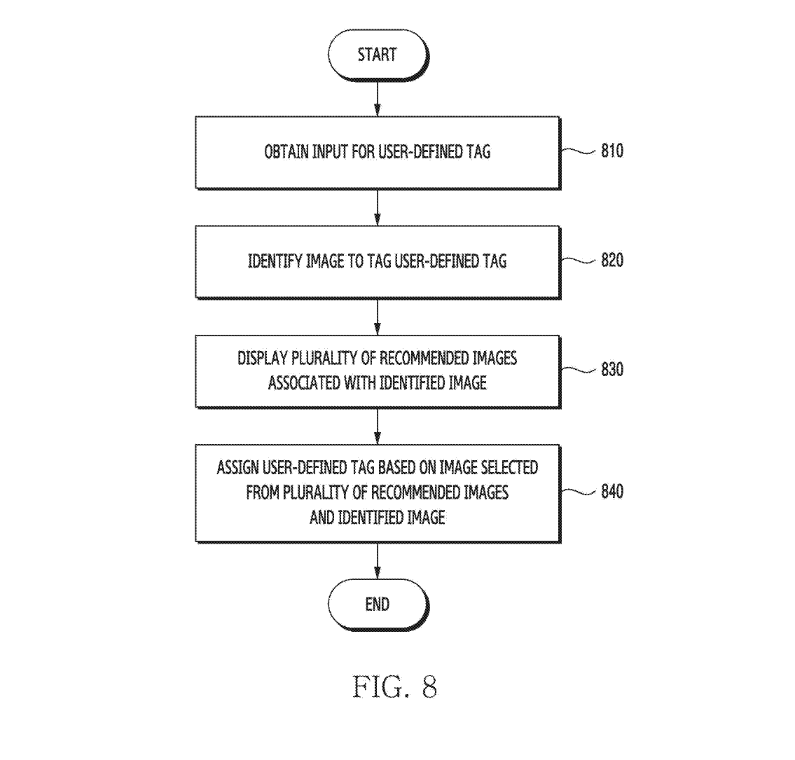

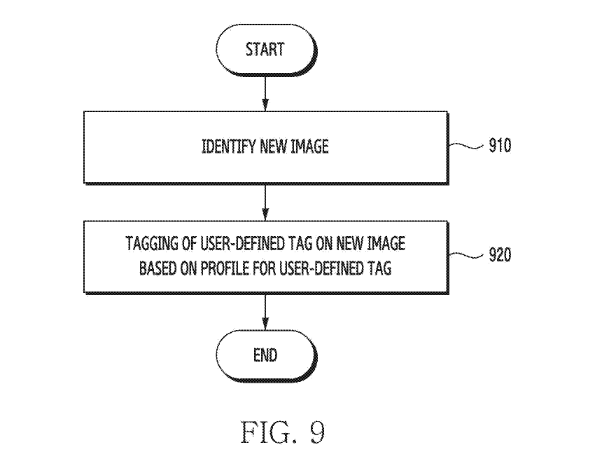

In an embodiment, the processor 120 may be used to execute operations of the electronic device 101 to be exemplified in description of FIGS. 8 and 9. For example, the processor 120 may include at least a portion of the processor 120 of FIG. 1 or may correspond to at least a portion of the processor 120 of FIG. 1. For example, the processor 120 may include one or more processors including an application processor (AP) and/or a communication processor (CP). For example, the processor 120 may be implemented as a single chip such as a system on chip (SoC) or may also be implemented as a plurality of chips. For example, the processor 120 may be implemented as one integrated circuit or may also be implemented as a plurality of integrated circuits. For example, the processor 120 may also be arranged in a distributed manner within the electronic device 101. For example, the processor 120 may correspond to a plurality of processors that divide a plurality of operations between processors and collectively perform the operations.

In an embodiment, the memory 130 may (at least temporarily) store instructions for executing operations of the electronic device 101 to be exemplified in descriptions of FIGS. 8 and 9. The instructions may be executed by the processor 120. The instructions may be included in one or more programs 140 stored in the memory 130. For example, the memory 130 may include at least a portion of the memory 130 (or at least a portion of nonvolatile memory 134) of FIG. 1 or correspond to the at least a portion of the memory 130 (or the at least a portion of the nonvolatile memory 134) of FIG. 1. For example, the memory 130 may include main memory (e.g., random access memory (RAM) and/or read only memory (ROM)) in the electronic device 101, a register for the processor 120, a cache for the processor 120, a register for the communication circuitry 290, a buffer (or a soft buffer) for the communication circuitry 290, and/or auxiliary memory (e.g., a hard disk drive (HDD) or a solid state drive (SSD)) of the electronic device 101. For example, the memory 130 may be implemented as a single chip or may also be implemented as a plurality of chips. For example, the memory 130 may be implemented as one integrated circuit or may also be implemented as a plurality of integrated circuits. For example, the memory 130 may also be arranged in a distributed manner within the electronic device 101.

In an embodiment, the input module 150 may include at least one physical key (e.g., buttons) for obtaining a user input. For example, the input module 150 may correspond to at least a portion of the input module 150 of FIG. 1.

In an embodiment, the display 260 may display visual content (e.g., an image). For example, the display 260 may include at least a portion of the display module 160 of FIG. 1, or may correspond to at least a portion of the display module 160 of FIG. 1.

In an embodiment, the communication circuitry 290 may be used for a communication connection between the electronic device 101 and another device (e.g., an electronic device 102 or a server 108). For example, the communication circuitry 290 may include at least a portion of the communication module 190 (or the wireless communication module 192) of FIG. 1, or may correspond to the at least a portion of the communication module 190 (or the wireless communication module 192) of FIG. 1. For example, the communication circuitry 290 may include communication circuitry for a long-distance communication network. For example, the communication circuitry 290 may be used to establish a communication link. For example, the communication circuitry 290 may be implemented as a single chip or may also be implemented as a plurality of chips. For example, the communication circuitry 290 may be implemented as one integrated circuit or may also be implemented as a plurality of integrated circuits. For example, the communication circuitry 290 may also be arranged in a distributed manner within the electronic device 101.

FIG. 2B is a block diagram of a program of an electronic device according to an embodiment of the disclosure.

FIG. 2B may be described with reference to FIGS. 1 and 2A.

Referring to FIG. 2B, the program 140 may include a plurality of applications (APPs) 211 and 215, a plurality of tagging modules 221 and 225, and a plurality of databases (DBs) 231, 233, 235, 237, and 239. In an embodiment, the program 140 may include an image analysis module 241, a data collection module 243, an intent analysis module 245, and a UD tag interface 250.

In an embodiment, the plurality of tagging modules 221 and 225 may include a predefined (PD) tag tagging module 221 and a user-defined (UD) tag tagging module 225. In an embodiment, the plurality of DBs 231, 233, 235, 237, and 239 may include a PD tag DB 231, a user profile DB 233, a meta information DB 235, a UD tag profile DB 237, and a UD tag DB 239. In an embodiment, a predefined tag may be a tag defining features that may be classified through content analysis and/or metadata analysis in the electronic device 101. In an embodiment, a user-defined tag may be distinguished from a tag based on features classifiable in the electronic device 101. For example, a user-defined tag may be a tag inputted by a user for the user to define a characteristic of content and to classify the content according to the defined characteristic. For example, at least a portion of the user-defined tag inputted by the user may overlap the predefined tag.

Hereinafter, with reference to FIGS. 1, 2A, 2B, 3, 4A, 4B, 5, 6A, 6B, 6C, 6D, 7A, and 7B, an operation of the electronic device 101 attaching (or tagging) a PD tag to an image, an operation of collecting data for a UD tag based on data associated with an application, and an operation of attaching (or tagging) a UD tag to an image according to an intention of the user are described. Herein, attaching (or tagging) a tag (e.g., a UD tag and/or a PD tag) to an image may be referred to as assigning (or designating) (or allocating) a tag (e.g., a UD tag and/or a PD tag) to an image.

### Tagging of a PD tag

In an embodiment, the image analysis module 241 may extract an image feature from images. In an embodiment, the image analysis module 241 may extract image features from images accessible through the first APP 211. In an embodiment, the first APP 211 may be a gallery application. However, it is not limited thereto. The first APP 211 may be any application (e.g., a web browser) capable of accessing images stored in the memory 130 or the server 108 of the electronic device 101. In an embodiment, the images may be images stored in the memory 130. However, it is not limited thereto. For example, the images may be images that are linked with a user account and stored in the server 108. In an embodiment, the image feature may represent at least one object included in the image. In an embodiment, the image feature may indicate a situation (e.g., travel, a wedding, exercise, a holiday, an anniversary, a specific person, or a specific place) depicted in the image by the at least one object (e.g., a person (e.g., a user), an animal, or an item) included in the image.

In an embodiment, the image analysis module 241 may extract an image feature from images by using an image encoder for extracting an image feature. However, it is not limited thereto. In an embodiment, the image analysis module 241 may extract an image feature from images by using an artificial intelligence (AI) model (e.g., a vision transformer (ViT)) trained to extract an image feature (or trained based on contrastive language-image pretraining (CLIP)). In an embodiment, the CLIP may be a training technique that quantifies an association between a text and an image. For example, via the CLIP, a text encoder of an AI model may transform a text into a text encoded vector. For example, via the CLIP, an image encoder of an AI model may transform an image into an image encoded vector. For example, via the CLIP, an AI model may calculate similarity (or cosine similarity) between vectors. In an embodiment, the AI model used by the image analysis module 241 may be a pre-trained AI model. In an embodiment, the AI model used by the image analysis module 241 may include a plurality of parameters associated with a neural network having a structure based on an encoder and a decoder, such as a transformer.

In an embodiment, the AI model may be included in the electronic device 101 or included in an external device (e.g., the server 108) and connected to the electronic device 101 through a network.

In an embodiment, the PD tag tagging module 221 may attach (or tag) a PD tag to images based on the image feature extracted from the image analysis module 241. In an embodiment, the PD tag tagging module 221 may attach (or tag) a word representing the image feature extracted from the image analysis module 241 as a PD tag to images. In an embodiment, attaching (or tagging) a PD tag to an image may include generating, by the PD tag tagging module 221, PD tag information associated with the image. For example, PD tag information being associated with an image may include the PD tag information being stored as meta information of the image. For example, PD tag information being associated with an image may include the PD tag information being stored in the PD tag DB 231.

In an embodiment, the PD tag tagging module 221 may store PD tag information associated with an image in the PD tag DB 231. In an embodiment, the PD tag DB 231 may be implemented as a designated database management system (e.g., SQLite). However, it is not limited thereto. In an embodiment, the PD tag tagging module 221 may store PD tag information associated with an image in meta information of the image. In an embodiment, the PD tag information may be stored as separate data dependent on an image and managed (e.g., stored, deleted, updated, or transmitted) together with the image.

### Data collection for a UD tag

In an embodiment, the data collection module 243 may obtain information associated with images through the plurality of APPs 211 and 215. In an embodiment, the data collection module 243 may store information associated with a user profile among information associated with images in the user profile DB 233 through the plurality of APPs 211 and 215. In an embodiment, the data collection module 243 may store meta information of an image among information associated with images in the meta information DB 235 through the plurality of APPs 211 and 215. In an embodiment, the user profile DB 233 and the meta information DB 235 may be implemented as a designated database management system (e.g., SQLite). In an embodiment, the user profile DB 233 may store data in a format (e.g., a knowledge graph) representing an association between objects.

In an embodiment, information associated with a user profile may include information (e.g., frequency of use of an APP, a category (or a type) of a frequently used APP (e.g., a shopping APP, a social network service (SNS) APP, a financial service APP, or a gallery APP), and/or a usage record of an APP (e.g., an internet search record in a case of a web browser, a multimedia search record, a multimedia viewing record, or a type (or a category) of viewed multimedia in a case of an APP for a multimedia playback, and/or an image search record or an image viewing record in a case of a gallery APP) associated with a usage history of an APP of the user. In an embodiment, the information related to the user profile may include information on a PD tag attached to images stored in the PD tag DB 231. For example, information associated with a user profile may include a PD tag of an image (e.g., a PD tag (e.g., a person, an animal, or an object) representing an object included in an image, and/or a PD tag (e.g., travel, wedding, exercise, holiday, or anniversary) indicating the situation described by the image. For example, information associated with a user profile may include information on the number of images to which the same PD tag is attached (or tagged), and/or a frequency (e.g., average image capture period) at which images to which the same PD tag is attached (or tagged) are captured.

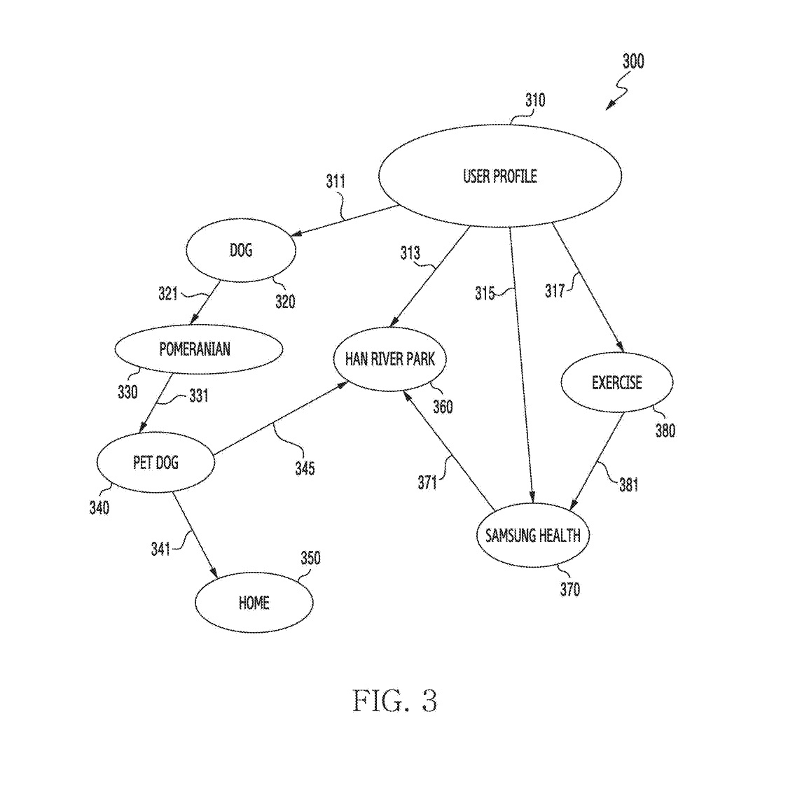

In an embodiment, the data collection module 243 may generate data representing an association (or a relationship) between one or more objects (or entities) (or nodes) based on information associated with the user profile. In an embodiment, the data collection module 243 may generate data having a structure in which one or more objects (or entities) (or nodes) are connected by an edge based on information associated with the user profile. Hereinafter, data representing an association (or a relationship) will be described with reference to FIG. 3.

FIG. 3 is a graph illustrating an association between objects according to an embodiment of the disclosure.

Referring to FIG. 3, a knowledge graph 300 may illustrate a connection relationship between one or more objects 320, 330, 340, 350, 360, 370, and 380 related to a user profile 310.

For example, a user may frequently (or most often) capture a picture of the dog 320. In this case, a relationship 311 between the user and the dog 320 may represent a target that the user has frequently (or most often) captured a picture of. For example, among the dogs 320 included in the picture, the most frequently (or most often) captured breed may be the Pomeranian 330. In this case, a relationship 321 between the dog 320 and the Pomeranian 330 may represent a breed that is frequently captured. For example, the Pomeranian 330 included in the picture may be defined as the pet dog 340 with the highest probability. In this case, a relationship 331 between the Pomeranian 330 and the pet dog 340 may represent a role of the Pomeranian 330. For example, the pet dog 340 included in the picture may be frequently (or most often) captured in a home 350 and/or the Han River Park 360. In this case, a relationship 341 or 345 between the pet dog 340 and the home 350 and/or the Han River Park 360 may represent a place where the pet dog 340 is most frequently captured.

For example, the user may frequently (or most often) visit the Han River Park 360. In this case, a relationship 313 between the user and the Han River Park 360 may represent a place frequently (or most often) visited by the user. In FIG. 3, it is illustrated that there is no association from the Han River Park 360 to another object, but it is merely an example. According to an embodiment, data indicating an association from the Han River park 360 to one or more objects (e.g., food and a friend) not illustrated in FIG. 3 may be stored in a user profile DB 233.

For example, the user may frequently (or most often) execute the Samsung Health 370. In this case, a relationship 315 between the user and the Samsung Health 370 may represent an application frequently (or most often) executed by the user. For example, the Samsung Health 370 may be executed most frequently (or most often) in the Han River Park 360. In this case, a relationship 371 between the Samsung Health 370 and the Han River Park 360 may represent a place where the Samsung Health 370 is frequently executed.

For example, the user may frequently (or most often) capture a picture of the exercise 380. Alternatively, for example, the user may frequently (or most often) capture a picture during the exercise 380. In this case, a relationship 317 between the user and the exercise 380 may represent the most state of the user when capturing a picture. For example, the Samsung Health 370 may be executed most frequently (or most often) during the exercise 380. In this case, a relationship 381 between the exercise 380 and the Samsung Health 370 may represent an application frequently executed during the exercise 380.

In an embodiment, a data collection module 243 may store information on the knowledge graph 300 illustrating the connection relationship between the one or more objects 320, 330, 340, 350, 360, 370, and 380 related to the user profile 310 in the user profile DB 233.

In an embodiment, meta information of an image may include picture capture information (e.g., a capture date and time, a capture location, an audio record at the time of capturing (e.g., a type of audio being played or conversation content thereof), or a schedule at the time of capturing (e.g., a schedule recorded in a calendar application)).

In an embodiment, meta information of an image may include generation information of the image (e.g., in a case of a screenshot image, information related to the screenshot (e.g., a name of an APP in which the screenshot was performed (e.g., a name of a social network service (SNS) APP or a name of a web browser), a type (or a purpose) of the APP in which the screenshot was performed (e.g., SNS, shopping, or web browsing), or information included in the screenshot (e.g., in a case that the APP in which the screenshot was performed is an APP for web browsing, a website address, and/or in a case that the APP in which the screenshot was performed is an APP for multimedia playback, a title of a video, or a category of a video))).

In an embodiment, meta information of an image may include image sharing information (e.g., an application in which sharing is performed (e.g., an SNS APP) and/or a function (e.g., quick share), sharer information (e.g., information on whether a person is stored in a contact, and, in a case of being stored in a contact, information on a relationship with the user)).

In an embodiment, meta information of an image may include information related to storage of the image (e.g., whether the image is stored in another path other than a basic storage path of the image, a path where the image is stored (e.g., a folder name), or a commonality between other images stored together in the path where the image is stored).

In an embodiment, meta information of an image may include other information related to the image (e.g., whether the image is edited (or corrected), and/or the number of views of the image).

In an embodiment, the data collection module 243 may encode each of one or more objects (or entities) (or nodes) into a vector (e.g., a text encoded vector). In an embodiment, the data collection module 243 may encode each of one or more objects (or entities) (or nodes) into a vector (e.g., a text encoded vector) through a text encoder (or a text encoder of an AI model trained through CLIP). In an embodiment, the data collection module 243 may allocate a vector to each of one or more objects (or entities) (or nodes).

### Tagging of a UD tag

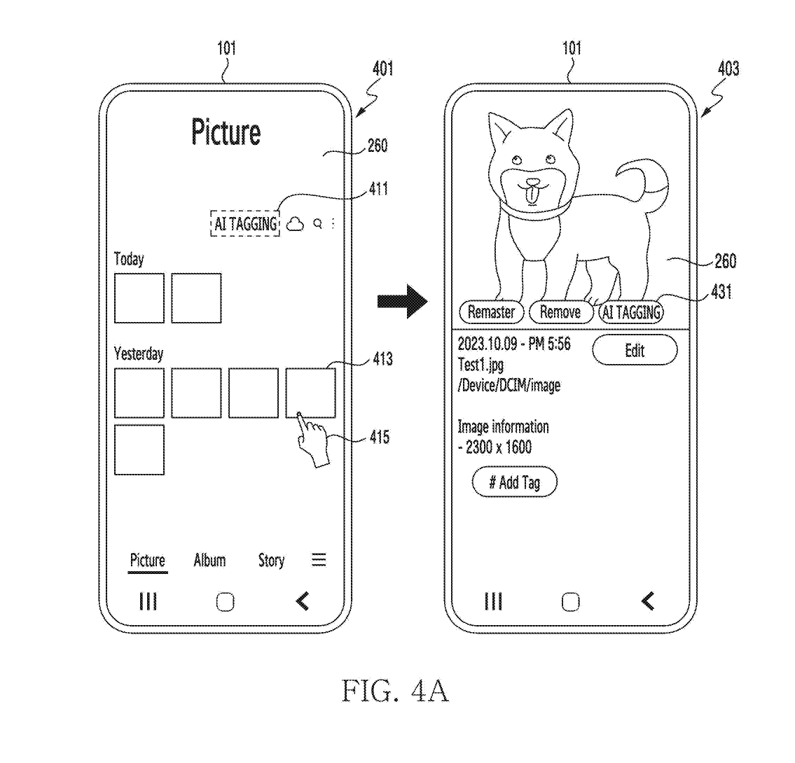

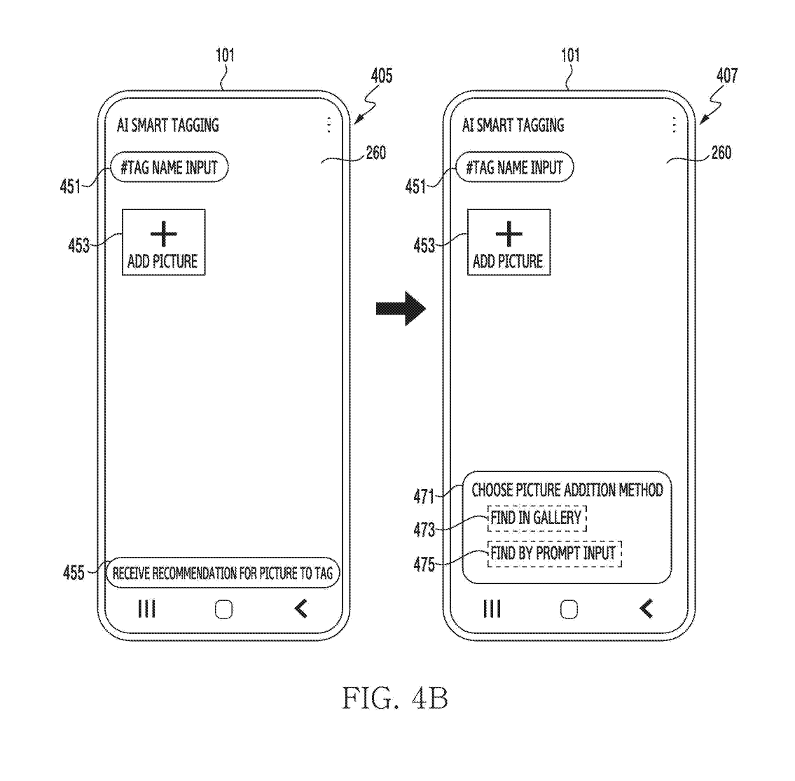

In an embodiment, a UD tag interface 250 may be a user interface (UI) (or a graphic user interface (GUI)) displayed through a display 260. In an embodiment, the UD tag interface 250 may be a UI (or a GUI) for generating (or correcting) and/or attaching (or tagging) a UD tag. In an embodiment, the UD tag interface 250 may be displayed on the display 260 based on execution of a gallery application. In an embodiment, the UD tag interface 250 may be displayed on the display 260 based on obtaining of an input for an item (or an image object) (or a text object) (or an executable object) (or a UI) included in a screen of the gallery application. Hereinafter, the operation for displaying the UD tag interface 250 on the screen of the gallery application may be described with reference to FIG. 4A.

FIG. 4A is a diagram illustrating an example of a screen of an electronic device according to an embodiment of the disclosure.

Referring to FIG. 4A, as a gallery application is executed, a screen 401 may be displayed on a display 260 of an electronic device 101. An item 411 (or an image object) (or a text object) (or an executable object) (or a UI) for AI tagging (or a UD tag) may be displayed on the screen 401.

In an embodiment, in response to a user input 415 for selecting one image 413 among one or more images displayed through the screen 401, a screen 403 for displaying the image 413 may be displayed on the display 260 of the electronic device 101. On the screen 403, an item 431 (or an image object) (or a text object) (or an executable object) (or a UI) for AI tagging (or a UD tag) may be displayed.

In an embodiment, the electronic device 101 may display a UD tag interface 250 on the display 260 in response to a user input to the AI tagging 411 on the screen 401 or the AI tagging 431 on the screen 403.

In an embodiment, the UD tag interface 250 may include an item for inputting a name of a UD tag, an item for adding an image to which a UD tag is to be attached (or tagged), and/or an item for receiving a recommendation of an image to which a UD tag is to be attached (or tagged). Hereinafter, the UD tag interface 250 may be described with reference to FIG. 4B.

FIG. 4B is a diagram illustrating an example of a screen of an electronic device according to an embodiment of the disclosure.

Referring to FIG. 4B, a screen 405 representing the UD tag interface 250 may be displayed on the display 260 of the electronic device 101. On the screen 405, an item 451 (or an image object) (or a text object) (or an executable object) (or a UI) for a tag name input (or a name of a UD tag) may be displayed. In an embodiment, a UD tag name may be obtained through a user input to the item 451 for a tag name input (or a name of a UD tag). For example, a user interface (UI) for a tag name input (or a name of a UD tag) may be displayed on the screen 405 based on an input (e.g., a touch input for the item 451) for a user to select the item 451. Based on another user input to the UI for a tag name input (or a name of a UD tag), the UD tag name may be displayed in the item 451 on the screen 405. In an embodiment, another UD tag, a PD tag, or a tag designated or generated by an AI model may be displayed on the item 451 or adjacent to the item 451.

On the screen 405, an item 453 (or an image object) (or a text object) (or an executable object) (or a UI) for adding a picture to which a UD tag is to be attached may be displayed. On the screen 405, an item 455 (or an image object) (or a text object) (or an executable object) (or a UI) for receiving a recommendation of a picture to which a UD tag is to be attached may be displayed in a deactivated state. In an embodiment, the item 455 for receiving a recommendation of a picture may be displayed in an activated state as a designated condition is satisfied (e.g., one or more pictures to which a UD tag is to be attached (or tagged) are selected). However, it is not limited thereto. The item 455 (or an image object) (or a text object) (or an executable object) (or a UI) for receiving a recommendation of a picture to which a UD tag is to be attached may not be displayed on the screen 405. The item 455 for receiving a recommendation of a picture to which a UD tag is to be attached may be displayed as a designated condition is satisfied (e.g., one or more pictures to which a UD tag is to be attached (or tagged) are selected). According to an embodiment, the UD tag interface 250 may be included as a portion of the gallery application. For example, the UD tag interface 250 being included as a portion of the gallery application may refer to the UD tag interface 250 being displayed on the display 260 as a portion of a screen showing an execution result of the gallery application.

In an embodiment, a screen 407 may be displayed in response to a user input of selecting the item 453 on the screen 405. On the screen 407, an item 471 (or an image object) (or a text object) (or an executable object) (or a UI) inquiring selection of a picture addition method may be displayed. In an embodiment, the item 471 inquiring selection of a picture addition method may include an item 473 for finding in a gallery and an item 475 for finding by a prompt input. In an embodiment, the prompt may include data for guiding selection of images for attaching (or tagging) a UD tag. In an embodiment, the prompt may be a work instruction for a generative artificial intelligence (AI) model (not illustrated). In an embodiment, the prompt may be a set of words (or a sentence including words) for selecting images for attaching (or tagging) a UD tag through the generative AI model. In an embodiment, the generative AI model may be a pre-trained AI model. In an embodiment, the generative AI model may include a plurality of parameters associated with a neural network having a structure based on an encoder and a decoder, such as a transformer.

In an embodiment, a list of images stored in the electronic device 101 or images (e.g., images stored in a server) connected to an account of the user may be displayed on the display 260 in response to a user input of selecting the find in gallery item 473. A user may select, from the list, an image (e.g., a picture or a video) for which a tag (e.g., a UD tag) is to be designated.

In an embodiment, when the add picture item 453 is selected, instead of displaying the item 471 inquiring selection of a picture addition method, a list of images stored in the electronic device 101 or images (e.g., images stored in the server) connected to an account of the user may be displayed on the display 260. The user may select, from the list, an image (e.g., a picture or a video) for which a tag (e.g., a UD tag) is to be designated. The find by prompt input item 475 may be provided as a separate menu. In an embodiment, the electronic device 101 may display images initially selected by the user through the UD tag interface 250.

In an embodiment, an intent analysis module 245 may identify an intention of the user. In an embodiment, the intent analysis module 245 may identify an intention of the user based on a user input to the item 455 for receiving a recommendation of a picture to which a UD tag is to be attached. For example, the intention of the user may be associated with a criterion for attaching a UD tag. However, it is not limited thereto. The intent analysis module 245 may identify an intention of the user based on a user input for the item 453 for adding a picture to which a UD tag is to be attached. For example, the intent analysis module 245 may identify an intention of the user according to some pictures selected by the user among pictures displayed based on the user input to the item 453 for adding a picture to which a UD tag is to be attached. In an embodiment, the screen for selecting a picture may be a screen for displaying a list of pictures stored in the electronic device 101 (or linked with an account of the user of the electronic device 101) as a thumbnail.

In an embodiment, the intent analysis module 245 may select (or identify) one or more candidate images (or recommended images) for identifying an intention of the user. In an embodiment, the intent analysis module 245 may select (or identify) one or more candidate images (or recommended images) based on a characteristic (e.g., a commonality) of images selected by a user input. In an embodiment, the intent analysis module 245 may select (or identify) one or more candidate images (or recommended images) that have a commonality (e.g., a visual commonality and/or a non-visual commonality) with images selected by a user input. Hereinafter, the candidate image may be referred to as a recommended image.

In an embodiment, the one or more candidate images may include at least one candidate image having a visual commonality with images selected by a user input. In an embodiment, the intent analysis module 245 may select (or identify) an image including at least one PD tag attached to a designated number or more of the selected images among PD tags of the selected images as a candidate image having a visual commonality. For example, the intent analysis module 245 may identify an image to which a PD tag 'Dog' is attached (or tagged) as a candidate image in a case that the PD tag 'Dog' among PD tags of the selected images is greater than or equal to a designated number. In an embodiment, the intent analysis module 245 may select (or identify) an image in which similarity with each of the selected images is greater than or equal to reference similarity as a candidate image having a visual commonality. In an embodiment, the similarity between images may be identified based on a distance (or cosine similarity) between vectors (e.g., image encoded vectors) of the images. In an embodiment, the image encoded vector may be obtained by an image encoder of an AI model through CLIP.

In an embodiment, the one or more candidate images may include at least one candidate image having a non-visual commonality with images selected by a user input.

In an embodiment, the intent analysis module 245 may identify (or select) at least one candidate image having a non-visual commonality with the selected images, based on data stored in a user profile DB 233. For example, the intent analysis module 245 may select (or identify) an image including an object having an association with objects included in the selected images as a candidate image with a non-visual commonality based on data (e.g., a knowledge graph) indicating an association between objects. For example, the intent analysis module 245 may identify an image to which another PD tag (e.g., a park) having an association with the PD tag 'Dog' of the selected images is attached (or tagged) as a candidate image.

For example, the intent analysis module 245 may select (or identify) an image having an image encoded vector having a high similarity with a text encoded vector of words (e.g., 'Dog', 'Pomeranian', 'Han River Park', and 'Samsung Health') having an association with objects included in the selected images, based on data (e.g., a knowledge graph) indicating an association between objects, as a candidate image having a non-visual commonality. For example, a word having an association with objects included in the selected images may refer to representing a node connected to objects included in the selected images through a knowledge graph 300.

In an embodiment, the intent analysis module 245 may identify (or select) at least one candidate image having a non-visual commonality with the selected images based on data stored in a meta information DB 235.

In an embodiment, the intent analysis module 245 may select (or identify) an image having the same (or similar) meta information as meta information of the selected images as a candidate image having a non-visual commonality, based on meta information of images. For example, the intent analysis module 245 may select (or identify), as a candidate image having a non-visual commonality, an image having the same picture capture information as the selected images, at least a portion of which picture capture information (e.g., a capture date, a capture time, and/or a capture location) of the selected images is identical. For example, the intent analysis module 245 may select (or identify), as a candidate image having a non-visual commonality, an image having the same image sharing information as the selected images, at least a portion of which image sharing information of the selected images is identical. However, it is not limited thereto.

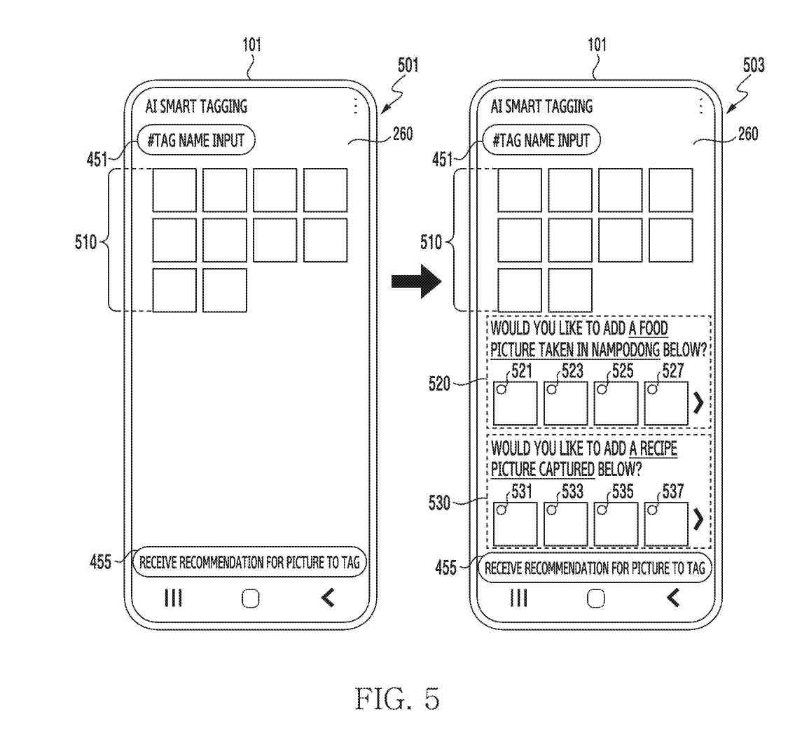

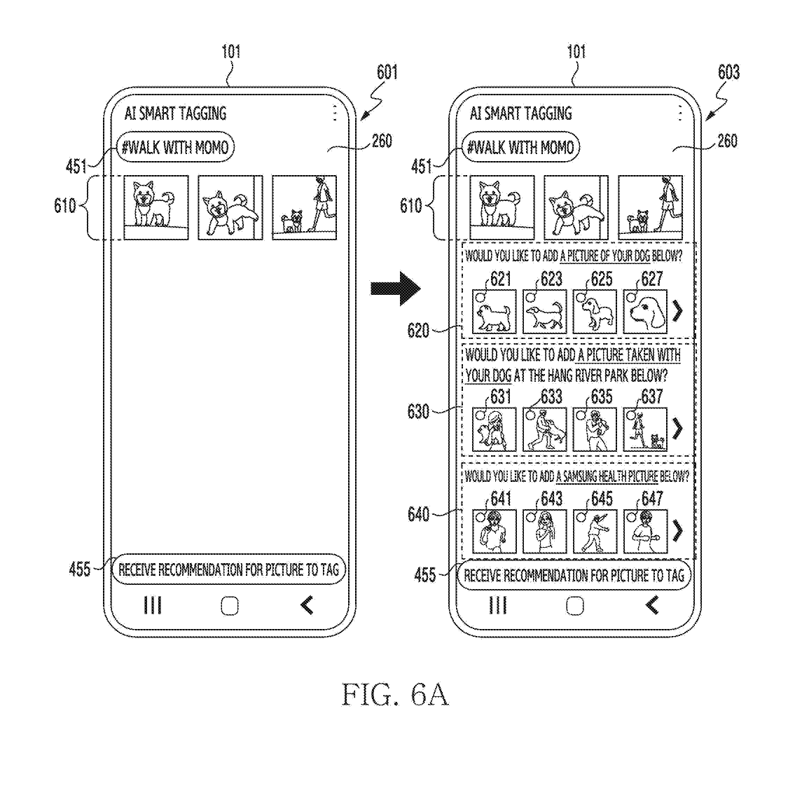

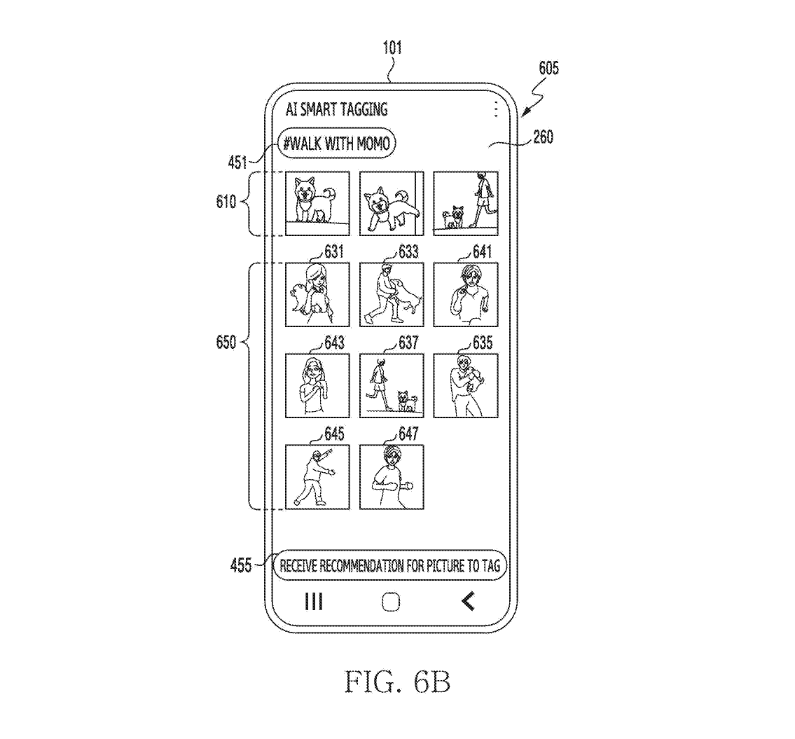

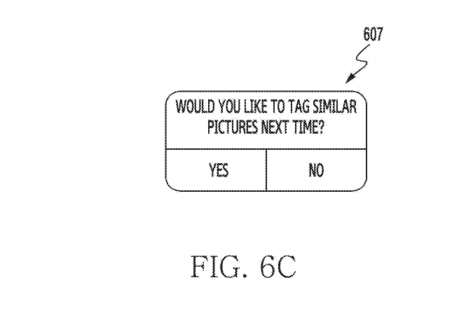

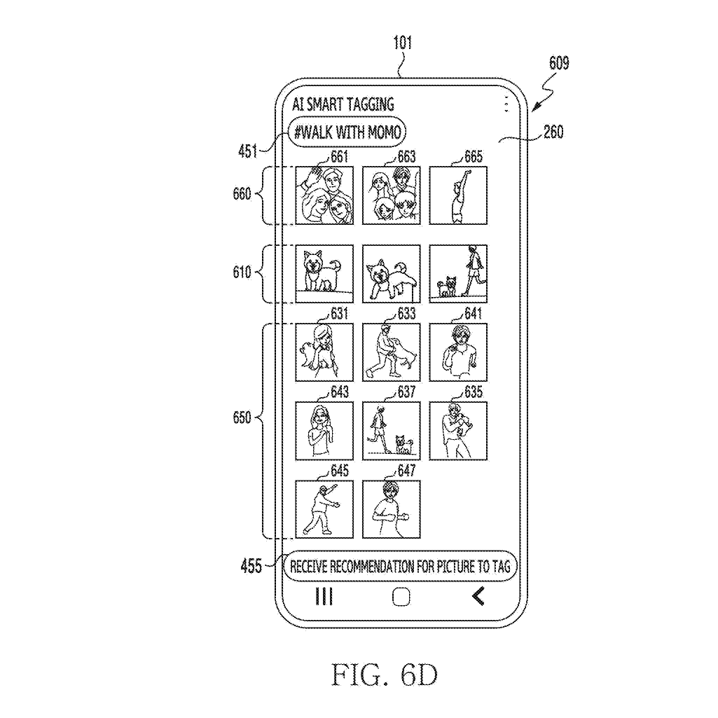

In an embodiment, the intent analysis module 245 may present one or more candidate images for identifying an intention of the user, to the user. In an embodiment, the intent analysis module 245 may display one or more candidate images for identifying an intention of the user through the display 260. In an embodiment, the intent analysis module 245 may display a UI requesting selection of an image to which a UD tag is to be attached (or tagged) among one or more candidate images through the display 260. Hereinafter, the operation for displaying a UI requesting selection of an image to which a UD tag is to be attached (or tagged) among one or more candidate images on the screen of the gallery application may be described with reference to FIGS. 5 and 6A.

FIG. 5 is a diagram illustrating an example of a screen of an electronic device according to an embodiment of the disclosure.

Referring to FIG. 5, a screen 501 may be displayed on a display 260 of an electronic device 101 as a user selects one or more pictures 510 to which a UD tag is to be attached (or tagged). In an embodiment, a screen 503 may be displayed in response to a user input of selecting an item 455 on the screen 501.

On the screen 503, candidate pictures 520 and 530 selected according to different criteria may be displayed.

For example, the candidate pictures 520 may include pictures 521, 523, 525, and 527 having a commonality with the one or more pictures 510. For example, the candidate pictures 520 may include the pictures 521, 523, 525, and 527 having a visual commonality (e.g., PD tag 'Food') with the one or more pictures 510. For example, the candidate pictures 520 may include the pictures 521, 523, 525, and 527 having a visual commonality (e.g., PD tag 'Food') and a non-visual commonality (e.g., capture location 'Nampodong') with the one or more pictures 510.

For example, the candidate pictures 530 may include pictures 531, 533, 535, and 537 having a commonality with the one or more pictures 510. For example, the candidate pictures 530 may include the pictures 531, 533, 535, and 537 having a visual commonality (e.g., PD tag 'Food') with the one or more pictures 510. For example, the candidate pictures 530 may include the pictures 531, 533, 535, and 537 having a visual commonality (e.g., PD tag 'Food') and a non-visual commonality (e.g., PD tag (or object) 'Recipe' having an association) with the one or more pictures 510.

FIG. 6A is a diagram illustrating an example of a screen of an electronic device according to an embodiment of the disclosure.

FIG. 6B is a diagram illustrating an example of a screen of an electronic device according to an embodiment of the disclosure.

Referring to FIG. 6A, a screen 601 may be displayed on a display 260 of an electronic device 101 as a user selects one or more pictures 610 to which a UD tag is to be attached (or tagged). In an embodiment, a UD tag name indicated by an item 451 displayed on the screen 601 may be "a walk with Momo". In an embodiment, the UD tag name may be inputted by the user selecting the item 451 before selecting the pictures 610. In an embodiment, the UD tag name may be inputted by the user selecting the item 451 before selecting a picture recommendation item 455 after selecting the pictures 610. In an embodiment, the UD tag name may be inputted by automatically displaying a user interface (UI) for a UD tag name after the user selects the pictures 610. For example, when the user selects the pictures 610, a UI including a word recommended as a user-defined tag and/or a predefined tag may be provided based on information on the selected pictures 610. As an example, the user may form and/or designate one or more user-defined tags by using the recommended word or the predefined tag, and the user may also additionally designate a predefined tag in addition to the user-defined tag formed by the user.

In an embodiment, the pictures 610 may have a PD tag of "Dog" (or "Pomeranian") (or "Pet dog"). In an embodiment, a screen 603 may be displayed in response to a user input of selecting the item 455 on the screen 601. On the screen 603, candidate pictures 620, 630, and 640 selected according to different criteria may be displayed. For example, in an area where the candidate pictures 620, 630, and 640 are displayed, information (e.g., 'Would you like to add a picture of your dog below?', 'Would you like to add a picture taken with your dog at the Hang River Park below?', or 'Would you like to add a Samsung Health picture below?') indicating an association with the one or more pictures 610 may be displayed. For example, the candidate pictures 620, 630, and 640 may be sequentially displayed. For example, the candidate pictures 620 may be displayed based on the one or more pictures 610 being selected. For example, the candidate pictures 630 may be displayed based on at least one of the candidate pictures 620 being selected. For example, the candidate pictures 640 may be displayed based on at least one of the candidate pictures 630 being selected. An order in which the candidate pictures 620, 630, and 640 are arranged on a screen may be based on a priority according to an association between each of the candidate pictures 620, 630, and 640 and the one or more pictures 610. For example, an order of providing the candidate pictures 620, 630, and 640 may be determined in an order in which a distance from a knowledge graph 300 is close. However, it is not limited thereto.

For example, the candidate pictures 620 may include pictures 621, 623, 625, and 627 having a commonality with the one or more pictures 610. For example, the candidate pictures 620 may include the pictures 621, 623, 625, and 627 having a visual commonality (e.g., a PD tag 'Pet dog') with the one or more pictures 610. For example, a picture including an object included in two or more of the one or more pictures 610 may be included as the candidate pictures 620. For example, a picture including a PD tag associated with an object included in two or more of the one or more pictures 610 may be included as the candidate pictures 620. In an embodiment, at least one difference may exist between the pictures 621, 623, 625, and 627 having a visual commonality (e.g., a PD tag 'Pet dog') with the one or more pictures 610. For example, there may be no commonality between the pictures 621, 623, 625, and 627 other than a commonality with the one or more pictures 610.

For example, the candidate pictures 630 may include pictures 631, 633, 635, and 637 having a visual commonality (e.g., a PD tag 'Pet dog') with the one or more pictures 610. For example, the candidate pictures 630 may include the pictures 631, 633, 635, and 637 having a visual commonality (e.g., a PD tag 'Pet dog') and a non-visual commonality (e.g., capture location 'Han River Park') with the one or more pictures 610. In an embodiment, at least one difference may exist between the pictures 631, 633, 635, and 637 having a visual commonality (e.g., a PD tag 'Pet dog') with the one or more pictures 610. For example, there may be no commonality between the pictures 631, 633, 635, and 637 other than a commonality with the one or more pictures 610.

For example, the candidate pictures 640 may include pictures 641, 643, 645, and 647 having a non-visual commonality (e.g., a PD tag (or an object) 'Samsung Health' having an association) with the one or more pictures 610. In an embodiment, at least one difference may exist between the pictures 641, 643, 645, and 647 having a visual commonality (e.g., a PD tag 'Pet dog') with the one or more pictures 610. For example, there may be no commonality between the pictures 641, 643, 645, and 647 other than a commonality with the one or more pictures 610.

In an embodiment, the candidate pictures 640 may include pictures having a shared record with another user who has shared the one or more pictures 610. In an embodiment, the candidate pictures 640 may include pictures having a record of sharing or generating through the same application as an application shared or generated the one or more pictures 610.

In an embodiment, the candidate pictures 640 may include pictures (e.g., a picture in which 'exercise' similar to a 'walk' included in the UD tag is included as a PD tag) in which a PD tag that matches at least a portion of content of the UD tag (e.g., a walk with Momo) inputted by the user is assigned.

In an embodiment, the candidate pictures 640 may include a picture having a connection relationship according to the knowledge graph 300 with the one or more pictures 610. For example, an application associated with exercise (e.g., an exercise record application), which is an event that occurred at a time or a place for walking with a pet dog, may be identified, and an image including a screen of the corresponding application may be included as one of the candidate pictures 640.

In an embodiment, an image file may include attribute information (e.g., metadata) including a capture date, a location, a lens type, a camera manufacturer, an aperture value, sensitivity, a shutter speed, brightness, resolution, a compression method, and the like. The attribute information may include, for example, information supported by an exchangeable image file format (EXIF). For example, the candidate pictures 640 may include pictures with a designated number or more (e.g., two) of attribute information identical to that of the one or more pictures 610.

In an embodiment, a UD tag, a PD tag, and/or a tag designated by an AI may be added to the image file as attribute information.

In an embodiment, on the screen 603, some pictures 650 of the candidate pictures 620, 630, and 640 selected according to different criteria based on a user input may be selected. According to an embodiment, based on the selection of some pictures 650 of the selected candidate pictures 620, 630, and 640 being completed (or a user input indicating the selection completion being obtained), the electronic device 101 may display a screen 605 according to FIG. 6B. For example, referring to FIG. 6B, the one or more pictures 610 initially selected by the user and additional pictures 631, 633, 635, 637, 641, 643, 645, and 647 selected from the candidate pictures 620, 630, and 640 may be displayed on the screen 605. The one or more pictures and the additionally selected pictures 650 may be assigned a UD tag (e.g., a walk with Momo).

In an embodiment, the one or more pictures 610 and the additionally selected pictures 650 may be additionally assigned not only the UD tag, but also a tag automatically determined by the electronic device 101 or an AI model. For example, the tag automatically determined by the AI model may be displayed adjacent to the item 451 on the screen 605.

In an embodiment, the one or more pictures 610 and the additionally selected pictures 650 may be assigned an additional UD tag.

In an embodiment, the one or more pictures 610 and the additionally selected pictures 650 may be assigned a common PD tag.

In an embodiment, the one or more pictures 610 and the additionally selected pictures 650 may be assigned a common UD tag (e.g., a walk with Momo), and only some of those pictures may be assigned another common UD tag and/or PD tag.

Referring to FIGS. 6A and 6B, it is illustrated that some of candidate pictures are additionally selected, but it is merely an example. According to an embodiment, all candidate pictures may not be additionally selected.

In an embodiment, the intent analysis module 245 may identify images selected from one or more candidate images through a UI requesting selection of an image, as an image to which a UD tag is to be attached (or tagged).

In an embodiment, the intent analysis module 245 may identify a UD tagging criterion (hereinafter, a UD tagging criterion) (or a profile for a UD tag) in association with an arbitrary UD tag. In an embodiment, the UD tagging criterion (or a profile for a UD tag) may be identified based on images initially selected by the user, additional images selected by the user among candidate images, and/or images not selected by the user among candidate images. For example, the intent analysis module 245 may identify a UD tagging criterion in association with a UD tag based on a commonality (e.g., a visual commonality and/or a non-visual commonality) between images initially selected by the user. For example, the intent analysis module 245 may identify a UD tagging criterion in association with a UD tag based on a commonality (e.g., a visual commonality and/or a non-visual commonality) between the initially selected images and/or the additionally selected images, by the user. For example, the intent analysis module 245 may identify a UD tagging criterion in association with a UD tag, based on a commonality between the initially selected images, the additionally selected images, and/or the unselected images, by the user. In an embodiment, the commonality between the initially selected images, the additionally selected images, and/or the unselected images, by the user, may be associated with a criterion for excluding an image in association with a UD tag.

In an embodiment, the intent analysis module 245 may determine (or set) a UD tagging criterion as one or more conditions in association with an arbitrary UD tag. In an embodiment, the intent analysis module 245 may determine (or set) a UD tagging criterion based on one or more vectors (e.g., a text encoded vector, and/or an image encoded vector) in association with an arbitrary UD tag. In an embodiment, the one or more vectors may be referred to as a vector for a UD tag. In an embodiment, the one or more vectors may be a vector indicating a visual commonality of images to which a UD tag is attached. In an embodiment, the one or more vectors may be a vector (or, a multimodal vector (e.g., a text encoded vector and/or an image encoded vector)) including a vector indicating a visual commonality and a vector indicating a non-visual commonality.

In an embodiment, the intent analysis module 245 may ask the user whether to store a UD tagging criterion in association with an arbitrary UD tag.

FIG. 6C is a diagram illustrating an example of a screen of an electronic device according to an embodiment of the disclosure. For example, the intent analysis module 245 of FIG. 6C may display, through the display 260, a menu 607 asking the user whether to store a UD tagging criterion in association with an arbitrary UD tag.

In an embodiment, the intent analysis module 245 may store a UD tagging criterion in a UD tag profile DB 237 in association with an arbitrary UD tag. In an embodiment, the intent analysis module 245 may store a UD tagging criterion (or a UD tag profile) in the UD tag profile DB 237 in response to a user input (e.g., a user input for 'Yes') that selects storage of the UD tagging criterion in association with an arbitrary UD tag for the menu 607.

In an embodiment, a UD tag tagging module 225 may attach (or tag) a UD tag to images stored in memory 130 or a server 108 of the electronic device 101 based on a condition (or a criterion) for attaching (or tagging) the UD tag.

For example, the UD tag tagging module 225 may attach (or tag) a UD tag to an image that satisfies one or more conditions. For example, the UD tag tagging module 225 may attach (or tag) a UD tag to an image in a case that similarity between a vector of the image and a vector for the UD tag (e.g., a text encoded vector and/or an image encoded vector) is greater than or equal to reference similarity. For example, the UD tag tagging module 225 may attach (or tag) a UD tag to the image in a case that the similarity between a vector of the image and a vector for a UD tag is greater than or equal to the reference similarity and the image has a non-visual commonality with the image to which the UD tag is attached.

In an embodiment, the UD tag tagging module 225 may store UD tag information associated with an image in a UD tag DB 239. In an embodiment, the UD tag DB 239 may be implemented as a designated database management system (e.g., SQLite). However, it is not limited thereto. In an embodiment, the UD tag tagging module 225 may store UD tag information in association with an image in meta information of the image. In an embodiment, UD tag information may be stored as separate data dependent on an image and managed (e.g., stored, deleted, updated, or transmitted) together with the image. In FIG. 2B, the UD tag DB 239 and the PD tag DB 231 are illustrated as different DBs, but it is merely an example. In the electronic device 101 according to an embodiment, data stored in the UD tag DB 239 and data stored in the PD tag DB 231 may be managed in one DB. Hereinafter, an operation in which the UD tag tagging module 225 tags a UD tag to a new image based on the UD tagging criterion may be described with reference to FIG. 6D.

FIG. 6D is a diagram illustrating an example of a screen of an electronic device according to an embodiment of the disclosure.

Referring to FIG. 6D, as new pictures are added (or captured), the UD tag tagging module 225 of the electronic device 101 may identify (or determine) whether a UD tag of the new pictures is tagged.

For example, the UD tag tagging module 225 may determine whether to tag a UD tag of the new pictures by using a UD tagging criterion based on the one or more pictures 610 initially selected and the additionally selected pictures 631, 633, 635, 637, 641, 643, 645, and 647, by the user. For example, the UD tag tagging module 225 may determine whether to tag a UD tag of the new pictures by using a UD tagging criterion based on the one or more pictures 610 initially selected, the additionally selected pictures 631, 633, 635, 637, 641, 643, 645, and 647, and unselected pictures 621, 623, 625, and 627, by the user.

In an embodiment, referring to a screen 609, a UD tag 'A walk with Momo' may be attached (or tagged) to pictures 660 selected based on a UD tagging criterion. For example, the screen 609 may display the one or more pictures 610 initially selected by the user, the additionally selected pictures 631, 633, 635, 637, 641, 643, 645, and 647, and automatically added pictures 661, 663, and 665.

The electronic device 101 as described above may tag a UD tag based on a user input. Accordingly, the electronic device 101 may attach phrases (or concepts) that are difficult to attach as a PD tag to images as a UD tag according to an intention of the user.

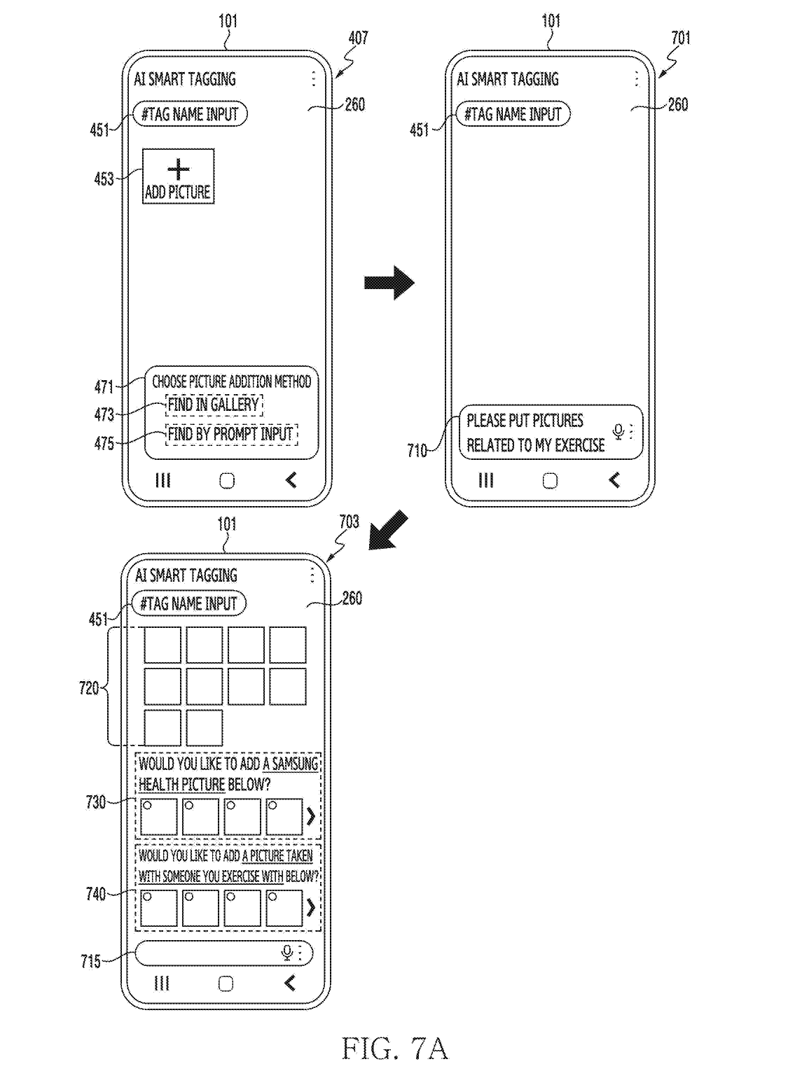

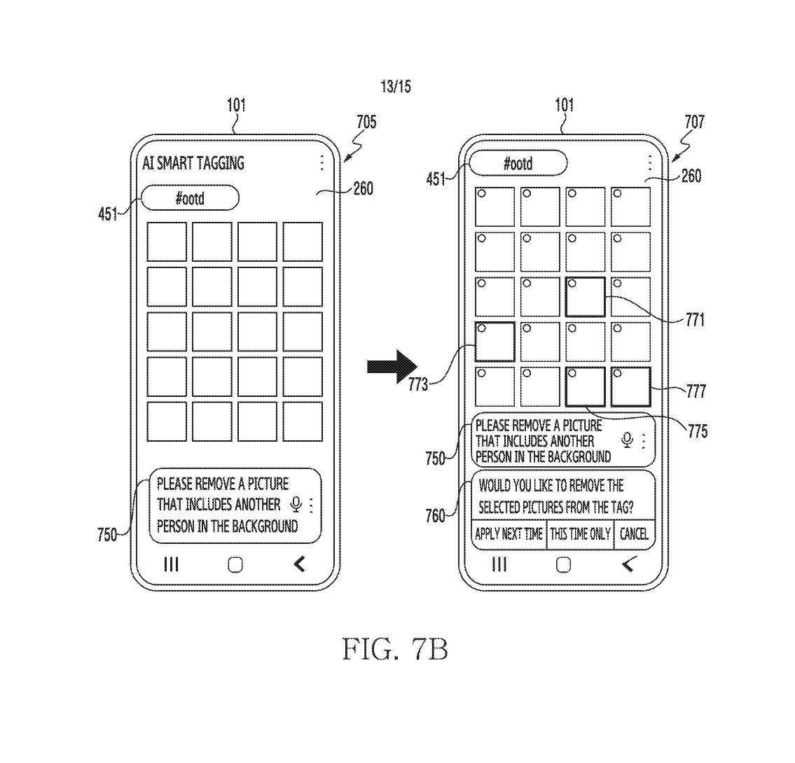

Hereinafter, referring to FIGS. 7A and 7B, another user input (e.g., a prompt input) for tagging of a UD tag and a UD tagging criterion stored in the UD tag profile DB 237 based on the another user input will be described.

FIG. 7A is a diagram illustrating an example of a screen of an electronic device according to an embodiment of the disclosure.

FIG. 7B is a diagram illustrating an example of a screen of an electronic device according to an embodiment of the disclosure.

In an embodiment, an electronic device 101 may display a UD tag interface 250 on a display 260. In an embodiment, the UD tag interface 250 may include an item for inputting a name of a UD tag, an item for adding an image to which a UD tag is to be attached (or tagged), and/or an item for receiving recommendation of an image to which a UD tag is to be attached (or tagged).

In an embodiment, a screen (e.g., the screen 405 of FIG. 4B) representing the UD tag interface 250 may be displayed on the display 260 of the electronic device 101. On a screen 405, an item 451 (or an image object) (or a text object) (or an executable object) (or a UI) for a tag name input (or a name of a UD tag) may be displayed. On the screen 405, an item 453 (or an image object) (or a text object) (or an executable object) (or a UI) for adding a picture to which a UD tag is to be attached may be displayed. On the screen 405, an item 455 (or an image object) (or a text object) (or an executable object) (or a UI) for receiving recommendation of a picture to which a UD tag is to be attached may be displayed.

In an embodiment, a screen 407 may be displayed in response to a user input of selecting the item 453 on the screen 405. Referring to FIG. 7A, an item 471 (or an image object) (or a text object) (or an executable object) (or a UI) inquiring selection of a picture addition method may be displayed on the screen 407. In an embodiment, the item 471 inquiring selection of a picture addition method may include an item 473 for finding in a gallery and an item 475 for finding by a prompt input. In an embodiment, the prompt may include data for guiding selection of images to attach (or tag) a UD tag. In an embodiment, the prompt may be a work instruction for a generative AI model (not illustrated). In an embodiment, the prompt may be a set of words (or a sentence including words) for selecting images for attaching (or tagging) a UD tag through the generative AI model. In an embodiment, the generative AI model may be a pre-trained AI model. In an embodiment, the generative AI model may include a plurality of parameters associated with a neural network having a structure based on an encoder and a decoder, such as a transformer.

In an embodiment, the electronic device 101 may display a screen 701 on the display 260 based on an input to the item 475 for finding by a prompt input. In an embodiment, the screen 701 may include an item 710 for inputting a prompt (e.g., 'Please put pictures related to my exercise'). In an embodiment, the prompt may be obtained through a touch input on the display 260. In an embodiment, the prompt may be obtained through an input (e.g., a keyboard input, a gesture input, and/or a voice input) through an input module 150.

In an embodiment, the electronic device 101 may perform one or more tasks by inputting a prompt to the generative AI model. In an embodiment, the electronic device 101 may perform a task for accessing one or more pictures stored in the electronic device 101 (or linked with a user account of the electronic device 101) by inputting a prompt to the generative AI model. In an embodiment, the electronic device 101 may perform a task of identifying (or selecting) some pictures having a commonality between one or more accessed pictures and a prompt (e.g., 'Please put pictures related to my exercise') by inputting a prompt to the generative AI model. In an embodiment, the electronic device 101 may perform a task for displaying some of the identified (or selected) pictures through the UD tag interface 250 by inputting a prompt to the generative AI model.

In an embodiment, the generative AI model may access pictures of a user by exchanging specific data with the electronic device 101 (e.g., a processor 120). For example, the generative AI model receiving the prompt may request the electronic device 101 for information (e.g., a storage location, account information, or the like) necessary to access pictures of the user and may access pictures of the user by using the information necessary to access pictures of the user provided from the electronic device 101. In an embodiment, since the generative AI model receiving the prompt may be previously allowed to access pictures of the user, the generative AI model may access pictures at a predetermined location and perform an operation according to the prompt.

In an embodiment, the generative AI model may notify (or provide) the electronic device 101 of an identifier (e.g., a storage location, a file name, an EXIF attribute, a PD tag, or the like) for pictures (e.g., 610, 620, 630, 640, 720, 730, or 740) to be displayed on a screen of the user.

In an embodiment, the electronic device 101 may display images identified (or selected) based on the prompt through the UD tag interface 250.

In an embodiment, an intent analysis module 245 may identify an intention of the user. In an embodiment, the intent analysis module 245 may identify an intention of the user based on a user input to an item for receiving recommendation of a picture to which a UD tag is to be attached. For example, the intention of the user may be associated with a criterion for attaching a UD tag.

In an embodiment, the intent analysis module 245 may select (or identify) one or more candidate images for identifying an intention of the user. In an embodiment, the intent analysis module 245 may select (or identify) one or more candidate images having a commonality (e.g., a visual commonality and/or a non-visual commonality) with images selected by a user input.

In an embodiment, the one or more candidate images may include at least one candidate image having a visual commonality with images selected by a user input. In an embodiment, the intent analysis module 245 may select (or identify), as a candidate image having a visual commonality, an image including at least one PD tag that is attached to a designated number or more of the selected images, among PD tags of the selected images. For example, the intent analysis module 245 may identify an image to which a PD tag 'Dog' is attached (or tagged) as a candidate image in a case that the PD tag 'Dog' among PD tags of the selected images is greater than or equal to a designated number. In an embodiment, the intent analysis module 245 may select (or identify) an image in which similarity with each of the selected images is greater than or equal to reference similarity as a candidate image having a visual commonality. In an embodiment, the similarity between images may be identified based on a distance (or cosine similarity) between vectors (e.g., image encoded vectors) of the images.

In an embodiment, the one or more candidate images may include at least one candidate image having a non-visual commonality with images selected by a user input.

In an embodiment, the intent analysis module 245 may identify (or select) at least one candidate image having a non-visual commonality with the selected images, based on data stored in a user profile DB 233. For example, the intent analysis module 245 may select (or identify) an image including an object having an association with objects included in the selected images as a candidate image with a non-visual commonality based on data (e.g., a knowledge graph) indicating an association between the objects. For example, the intent analysis module 245 may identify an image to which another PD tag (e.g., a park) having an association with the PD tag 'Dog' of the selected images is attached (or tagged), as a candidate image.

In an embodiment, the intent analysis module 245 may identify (or select) at least one candidate image having a non-visual commonality with the selected images based on data stored in a meta information DB 235.

In an embodiment, the intent analysis module 245 may present one or more candidate images for identifying an intention of the user, to the user. In an embodiment, the intent analysis module 245 may display one or more candidate images for identifying an intention of the user through the display 260.

Referring to FIG. 7A, the one or more pictures 720 selected according to a prompt may be displayed on a screen 703. In an embodiment, a UD tag name indicated by the item 451 displayed on the screen 703 may be "workout of the day (wod)". In an embodiment, the pictures 720 may have a PD tag of 'Exercise' (or 'Samsung Health').

In an embodiment, the user may first input "wod" into the UD tag item 451 and input "Please put pictures related to my exercise" as a prompt. The electronic device 101 may transmit the prompt including the "wod" to an AI model. The AI model may select pictures (e.g., an authentication picture captured once a day after completing a similar kind of exercise that is repeated periodically) that match the "wod" among pictures related to exercise of the user. In an embodiment, the user may also input the UD tag item 451 after pictures (e.g., 720, 730, or 740) are selected.

In an embodiment, the candidate pictures 730 and 740 selected according to different criteria may be displayed on the screen 703.

For example, the candidate pictures 730 and 740 may include pictures having a visual commonality (e.g., PD tag 'Exercise') with the one or more pictures 720. For example, the candidate pictures 730 may include pictures having a visual commonality (e.g., PD tag 'Exercise') and a non-visual commonality (e.g., PD tag 'Samsung Health' according to an association) with the one or more pictures 710. For example, the candidate pictures 740 may include pictures having a visual commonality (e.g., PD tag 'Exercise') and a non-visual commonality (e.g., a PD tag (or object) 'Person' having an association) with the one or more pictures 720.

In an embodiment, the electronic device 101 may input a prompt (e.g., 'Please remove pictures that include another person in the background') through an item 715 for inputting a prompt. In an embodiment, the prompt may be obtained through a touch input on the display 260. In an embodiment, the prompt may be obtained through an input (e.g., a keyboard input, a gesture input, and/or a voice input) through the input module 150.

Referring to FIG. 7B, the electronic device 101 may display a screen 705 into which a prompt 750 is inputted. In an embodiment, referring to a screen 707, the electronic device 101 may select pictures 771, 773, 775, and 777 that match a condition according to the prompt (e.g., have another person in the background) among pictures to which the UD tag 'Wod' is attached based on the prompt 750. In an embodiment, referring to the screen 707, the electronic device 101 may display a menu 760 asking whether to remove the selected pictures from the tag on the screen 707.

In an embodiment, the electronic device 101 may delete the UD tag 'Wod' (e.g., release designation of a UD tag) of the pictures 771, 773, 775, and 777 based on a user input to the menu 760. In an embodiment, the electronic device 101 may delete the UD tag 'Wod' of the pictures 771, 773, 775, and 777, based on a user input to some items (e.g., Apply next time and This time only) of the menu 760. In an embodiment, the intent analysis module 245 may update a UD tagging criterion for an intention of the user to delete the UD tag 'Wod' of the pictures 771, 773, 775, and 777 (i.e., an intention to 'exclude pictures that include another person in the background'). For example, the electronic device 101 may update a UD tagging criterion for an intention of the user to delete the UD tag 'Wod' of the pictures 771, 773, 775, and 777 (i.e., an intention to 'exclude pictures that include another person in the background'), based on a user input to some items (e.g., Apply next time) of the menu 760.

According to an embodiment, the electronic device 101 may receive, from another electronic device of another user through a communication module 190, an image in which a tag is attached. Through the communication module 190, the electronic device 101 may transmit (or suggest transmission of) (or recommend transmission of) another image to which a UD tag associated with a tag already attached to the image received from the another electronic device of the another user is attached, to the another electronic device of the another user. In an embodiment, the electronic device 101 may change the UD tag to another tag (e.g., a tag already attached to the image received from the another electronic device, or another third tag) and then transmit the image to the another electronic device. In an embodiment, universality and privacy may be considered for changing (or converting) the tag. For example, the changed third tag may be a universal tag. In a case that the UD tag is determined to have high privacy, the electronic device 101 may change the UD tag to another tag (e.g., a tag already attached to the image received from the another electronic device, or another third tag) and then transmit the image to the another electronic device. According to an embodiment, when displaying an image (or a thumbnail image) for previewing the image in which a tag is attached, from the another electronic device of the another user through the communication module 190, the electronic device 101 may display a UD tag to be assigned to the image together with the image for previewing (or a thumbnail image).

In an embodiment, the electronic device 101 may display (e.g., apply different colors, and/or fonts) different types of tags (e.g., a UD tag, a PD tag, and a tag automatically assigned by AI) to be distinguished from each other in a gallery application.

The electronic device 101 as described above is illustrated as tagging a UD tag on an image (or a picture), but it is merely an example. According to an embodiment, the electronic device 101 may attach a UD tag to a video, audio (e.g., a voice or music), a document, a web page, a contact, and/or an object recognized by an extended reality (XR) device in addition to an image.

According to an embodiment, the electronic device 101 may include audio (e.g., a voice or music) as content to which a tag is to be assigned. The electronic device 101 may recommend to the user audio to which a tag (e.g., a PD tag or a UD tag) is to be assigned, or may automatically assign a tag, by using information (e.g., content of voice, a speaker, a recording place, lyrics, genre, an artist, the number of playbacks, a playback place, or a playback time) included in the audio.

According to an embodiment, the electronic device 101 may include a document as content to which a tag is to be assigned. The electronic device 101 may recommend to the user a document to which a tag (e.g., a PD tag or a UD tag) is to be assigned, or may automatically assign a tag, by using information (e.g., content of writing, an attached image, a type of writing, a writer, a writing place, a writing time, a sharing history, or the number of views) included in the document.

According to an embodiment, the electronic device 101 may include an XR object (e.g., a person or an item recognized by an XR device) or an XR scene (e.g., a scene recognized by an XR device) as content to which a tag is to be assigned. The electronic device 101 may recommend to the user an object or a scene to which a tag (e.g., a PD tag or a UD tag) is to be assigned, or may automatically assign a tag, by using information (e.g., an object, movement of the object, a background, a place, or a time) collected through the XR device.

FIG. 8 is a flowchart illustrating an operation of an electronic device according to an embodiment of the disclosure.

FIG. 8 may be described with reference to FIGS. 1, 2A, 2B, 3, 4A, 4B, 5, 6A, 6B, 6C, 6D, 7A, and 7B.

In the following embodiment, each of operations may be sequentially performed, but are not necessarily performed sequentially. For example, an order of each of operations may be changed, and at least two operations may also be performed in parallel.

Referring to FIG. 8, in operation 810, according to an embodiment, an electronic device 101 may obtain an input for a user-defined (UD) tag. For example, the electronic device 101 may obtain an input (e.g., AI tagging 411 or a user input to AI tagging 431) for a UD tag through a UD tag interface 250. For example, the electronic device 101 may obtain an input (e.g., a user input to an item 473 for finding in a gallery and/or an item 475 for finding by a prompt input) for a UD tag through the UD tag interface 250.

In operation 820, according to an embodiment, the electronic device 101 may identify an image to tag a UD tag. For example, the electronic device 101 may identify an image to tag a UD tag among a plurality of images based on a user input.

For example, the user input may be an input of selecting an image from a screen for selecting images displayed on a display 260 by selecting an item 473 for finding in a gallery. For example, the electronic device 101 may identify images selected by a user as an image to tag a UD tag.

For example, the user input may be an input of a prompt after selecting the item 475 for finding by a prompt input. For example, the electronic device 101 may identify an image to tag a UD tag based on similarity between a text encoded vector for the prompt and an image encoded vector of each of a plurality of images.

In operation 830, according to an embodiment, the electronic device 101 may display a plurality of recommended images associated with the identified image.

In an embodiment, the electronic device 101 may select (or identify) one or more recommended images having a commonality (e.g., a visual commonality and/or a non-visual commonality) with images selected by a user input. In an embodiment, the one or more recommended images may include at least one recommended image having a visual commonality with the selected images. In an embodiment, the electronic device 101 may select (or identify), as a recommended image having a visual commonality, an image including at least one PD tag that is attached to a designated number or more of the selected images, among PD tags of the selected images. In an embodiment, the electronic device 101 may select (or identify) an image in which similarity with each of the selected images is greater than or equal to reference similarity as a recommended image having a visual commonality. In an embodiment, the similarity between images may be identified based on a distance (or cosine similarity) between vectors (e.g., image encoded vectors) of the images. In an embodiment, the image encoded vector may be obtained by an image encoder of an AI model through CLIP.

In an embodiment, the electronic device 101 may identify (or select) at least one recommended image having a non-visual commonality with the selected images based on data stored in a user profile DB 233. For example, the electronic device 101 may select (or identify) an image including an object having an association with objects included in the selected images as a recommended image with a non-visual commonality based on data (e.g., a knowledge graph) indicating an association between the objects. For example, the electronic device 101 may identify an image in which another PD tag (e.g., a park) having an association with a PD tag 'Dog' of the selected images is attached (or tagged) as a recommended image.

For example, the electronic device 101 may select (or identify) an image having an image encoded vector having a high similarity with a text encoded vector of words (e.g., 'Dog', 'Pomeranian', 'Han River park', and 'Samsung Health') indicating objects included in the selected images as a recommended image having a non-visual commonality based on data (e.g., a knowledge graph) indicating an association between the objects.

In an embodiment, the electronic device 101 may identify (or select) at least one recommended image having a non-visual commonality with the selected images based on data stored in a meta information DB 235.

In an embodiment, the electronic device 101 may select (or identify) an image having the same (or similar) meta information as meta information of the selected images as a recommended image having a non-visual commonality based on meta information of images. For example, the electronic device 101 may select (or identify), as a recommended image having a non-visual commonality, an image having the same picture capture information as the selected images, at least a portion of which picture capture information (e.g., a capture date, a capture time, and/or a capture location) of the selected images is identical. For example, the electronic device 101 may select (or identify), as a recommended image having a non-visual commonality, an image having the same image sharing information as the selected images, at least a portion of which image sharing information of the selected images is identical. However, it is not limited thereto.

In an embodiment, the electronic device 101 may present one or more recommended images for identifying an intention of the user, to the user. In an embodiment, the electronic device 101 may display the one or more recommended images for identifying an intention of the user through the display 260. In an embodiment, the electronic device 101 may display a UI requesting selection of an image to which a UD tag is to be attached (or tagged) among the one or more recommended images through the display 260.

In operation 840, according to an embodiment, the electronic device 101 may assign a user-defined tag based on an image selected from a plurality of recommended images and the identified image.

In an embodiment, the electronic device 101 may identify a profile for a UD tag based on an image selected from among the plurality of recommended images to which a user-defined tag is assigned and the identified image. In an embodiment, a profile for a UD tag may be identified based on images initially selected by the user, additional images selected among candidate images by the user, and/or images not selected among candidate images by the user. For example, the electronic device 101 may identify a UD tagging criterion in association with a UD tag based on a commonality (e.g., a visual commonality and/or a non-visual commonality) between the images initially selected by the user. For example, the electronic device 101 may identify a UD tagging criterion in association with a UD tag based on a commonality (e.g., a visual commonality and/or a non-visual commonality) between the initially selected images and/or the additionally selected images by the user. For example, the electronic device 101 may identify a UD tagging criterion in association with a UD tag based on a commonality between the initially selected images, the additionally selected images, and/or the unselected images by the user. In an embodiment, the commonality between the initially selected images, the additionally selected images, and/or the unselected images by the user may be associated with a criterion for excluding an image in association with a UD tag.

In an embodiment, the electronic device 101 may determine (or set) a UD tagging criterion to one or more conditions in association with an arbitrary UD tag. In an embodiment, the electronic device 101 may determine (or set) a UD tagging criterion based on one or more vectors (e.g., a text encoded vector, and/or an image encoded vector) in association with an arbitrary UD tag. In an embodiment, the one or more vectors may be referred to as a vector for a UD tag. In an embodiment, the one or more vectors may be a vector indicating a visual commonality of images to which a UD tag is attached. In an embodiment, the one or more vectors may be a vector (or a multimodal vector (e.g., a text encoded vector and/or an image encoded vector)) including a vector indicating a visual commonality and a vector indicating a non-visual commonality.

FIG. 9 is a flowchart illustrating an operation of an electronic device according to an embodiment of the disclosure.

FIG. 9 may be described with reference to FIGS. 1, 2A, 2B, 3, 4A, 4B, 5, 6A, 6B, 6C, 6D, 7A, and 7B.

In the following embodiment, each of operations may be sequentially performed, but are not necessarily performed sequentially. For example, an order of each of operations may be changed, and at least two operations may also be performed in parallel.

Operations of FIG. 9 may be performed after the operation 840 of FIG. 8.

Referring to FIG. 9, in operation 910, according to an embodiment, an electronic device 101 may identify a new image. In an embodiment, the electronic device 101 may identify that a new image is captured through a camera module 180. In an embodiment, the electronic device 101 may identify that a new image is shared through a communication module 190.

In operation 920, according to an embodiment, the electronic device 101 may perform tagging of a UD tag on a new image based on a profile for a UD tag. The electronic device 101 may perform tagging of a UD tag on a new image based on a UD tagging criterion (or a UD tag profile). For example, the electronic device 101 may attach (or tag) a UD tag to new images stored in memory 130 of the electronic device 101 based on a condition (or a criterion) for attaching (or tagging) a UD tag.

For example, the electronic device 101 may attach (or tag) a UD tag to an image that satisfies one or more conditions. For example, in a case that similarity between a vector of an image and a vector for a UD tag is greater than or equal to reference similarity, the electronic device 101 may attach (or tag) the UD tag to the image. For example, in a case that the similarity between a vector of an image and a vector for a UD tag is greater than or equal to the reference similarity, and the image has a non-visual commonality with the image to which the UD tag is attached, the electronic device 101 may attach (or tag) the UD tag to the image. However, it is not limited thereto.

An electronic device 101 as described above may include a display 260. The electronic device 101 may include at least one processor 120 including processing circuitry. The electronic device 101 may include memory 130 including one or more storage mediums storing instructions. The instructions, when executed by the at least one processor 120 individually or collectively, may cause the electronic device 101 to identify one or more first images 610 for assigning a tag defined by a user input. The instructions, when executed by the at least one processor 120 individually or collectively, may cause the electronic device 101 to, based on a characteristic of the one or more first images 610, display, through the display 260, a plurality of second images 620, 630, and 640 among a plurality of images. The instructions, when executed by the at least one processor 120 individually or collectively, may cause the electronic device 101 to assign the tag to the one or more first images 610 and at least one third image 631, 633, 635, 637, 641, 643, 645, and/or 647 selected by another user input among the plurality of second images 620, 630, and 640.

The plurality of second images 620, 630, and 640 may have at least one commonality of a non-visual commonality or a visual commonality with the one or more first images 610.

Some second images having the visual commonality with the one or more first images 610 among the plurality of second images 620, 630, and 640 may include a first object included in the one or more first images 610.

Another tag distinct from the tag, and/or a portion of meta information of other some second images having the non-visual commonality with the one or more first images 610 among the plurality of second images 620, 630, and 640 may correspond to another tag distinct from the tag, and/or a portion of meta information of the one or more first images 610.

The instructions, when executed by the at least one processor 120 individually or collectively, may cause the electronic device 101 to determine whether to assign the tag to a fourth image obtained through the camera based on a commonality between the one or more first images 610 and the at least one third image 631, 633, 635, 637, 641, 643, 645, and/or 647.

The instructions, when executed by the at least one processor 120 individually or collectively, may cause the electronic device 101 to identify a release of assignment of the tag with respect to at least one image among the at least one third image to which the tag is assigned and the one or more first images. The instructions, when executed by the at least one processor 120 individually or collectively, may cause the electronic device 101 to determine whether to assign the tag to a fifth image obtained through the camera, based on a difference between the at least one image from which the tag is released and the one or more first images and the at least one third image to which the tag is assigned.

The instructions, when executed by the at least one processor 120 individually or collectively, may cause the electronic device 101 to determine whether to assign the tag to an image based on a commonality between the one or more first images 610 and remaining images excluding the third image 631, 633, 635, 637, 641, 643, 645, or 647 among the plurality of second images 620, 630, and 640.

The instructions, when executed by the at least one processor 120 individually or collectively, may cause the electronic device 101 to, based on the user input, generate a prompt. The instructions, when executed by the at least one processor 120 individually or collectively, may cause the electronic device 101 to, by performing the prompt based on an artificial intelligence (AI) model, identify the one or more first images 610.

The plurality of second images 620, 630, and 640 may be displayed in different areas for different categories of the display 260. Each of the different areas may include a text object representing a different one of the different categories.

A method as described above may be performed by an electronic device 101 including a display 260. The method may include identifying one or more first images 610 for assigning a tag defined by a user input. The method may include, based on a characteristic of the one or more first images 610, displaying, through the display 260, a plurality of second images 620, 630, and 640 among a plurality of images. The method may include assigning the tag to the one or more first images 610 and at least one third image 631, 633, 635, 637, 641, 643, 645, or 647 selected by another user input among the plurality of second images 620, 630, and 640.

The plurality of second images 620, 630, and 640 may have at least one commonality of a non-visual commonality or a visual commonality with the one or more first images 610.

Some second images having the visual commonality with the one or more first images 610 among the plurality of second images 620, 630, and 640 may include a first object included in the one or more first images 610.

Another tag distinct from the tag, and/or a portion of meta information of other some second images having the non-visual commonality with the one or more first images 610 among the plurality of second images 620, 630, and 640 may correspond to another tag distinct from the tag, and/or a portion of meta information of the one or more first images 610.

The method may include determining whether to assign the tag to a fourth image obtained through a camera, based on a commonality between the one or more first images 610 and the at least one third image 631, 633, 635, 637, 641, 643, 645, and/or 647.

The method may include identifying a release of assignment of the tag with respect to at least one image among the at least one third image to which the tag is assigned and the one or more first images. The method may include determining whether to assign the tag to a fifth image obtained through a camera, based on a difference between the at least one image from which the tag is released and the one or more first images and the at least one third image to which the tag is assigned.

The method may include determining whether to assign the tag to an image based on a commonality between the one or more first images 610 and remaining images excluding the third image 631, 633, 635, 637, 641, 643, 645, or 647 among the plurality of second images 620, 630, and 640.

The method may include, based on the user input, generating a prompt. The method may include, by performing the prompt based on an artificial intelligence (AI) model, identifying the one or more first images 610.

The plurality of second images 620, 630, and 640 may be displayed in different areas for different categories of the display 260. Each of the different areas may include a text object representing a different one of the different categories.

The operation of displaying the plurality of second images 620, 630, and 640 through the display 260 may include an operation of determining an image that matches a designated criterion in association with at least one of user profile information as at least one of the plurality of second images. The user profile information may include a sharing record, application usage information, or user interest information.

The user interest information may include information on an application having an association with the tag.

The operation of displaying the plurality of second images 620, 630, and 640 through the display 260 may include an operation of determining an image including data generated by the application as one of the plurality of images.

The operation of identifying the one or more first images 610 may include an operation of displaying a user interface (UI) 471 including an object 473 for adding one or more images for assigning the tag and another object 475 for inputting a prompt based on obtaining of another user input for assigning the tag.

The method may include an operation of changing the tag of the requested one or more first images 610 to another tag based on receiving a request for transmitting the one or more first images 610.

A non-transitory computer readable storage medium as described above may store a program including instructions. The instructions, when executed individually or collectively by at least one processor 120 including processing circuitry of an electronic device 101 including a display 260, may cause the electronic device 101 to identify one or more first images 610 for assigning a tag defined by a user input. The instructions, when executed by the at least one processor 120 individually or collectively, may cause the electronic device 101 to, based on a characteristic of the one or more first images 610, display, through the display 260, a plurality of second images 620, 630, and 640 among a plurality of images. The instructions, when executed by the at least one processor 120 individually or collectively, may cause the electronic device 101 to assign the tag to the one or more first images 610 and at least one third image 631, 633, 635, 637, 641, 643, 645, and/or 647 selected by another user input among the plurality of second images 620, 630, and 640.

The plurality of second images 620, 630, and 640 may have at least one commonality of a non-visual commonality or a visual commonality with the one or more first images 610.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as "A or B," "at least one of A and B," "at least one of A or B," "A, B, or C," "at least one of A, B, and C," and "at least one of A, B, or C," may include any one of or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," or "connected with" another element (e.g., a second element), it means that the element may be coupled with the other element directly (e.g., wiredly), wirelessly, or via a third element.

As used in connection with various embodiments of the disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term "non-transitory" simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
memory, comprising one or more storage media, storing instructions; and
at least one processor comprising processing circuitry communicatively coupled to the display and the memory,
wherein the instructions, when executed by the at least one processor individually or collectively, cause the electronic device to:
identify one or more first images for assigning a tag defined by a user input,
based on a characteristic of the one or more first images, display, through the display, a plurality of second images among a plurality of images, and
assign the tag to the one or more first images and at least one third image selected by another user input among the plurality of second images.

2. The electronic device of claim 1, wherein the plurality of second images have at least one commonality of a non-visual commonality or a visual commonality with the one or more first images.

3. The electronic device of claim 2, wherein some second images having the visual commonality with the one or more first images among the plurality of second images include a first object included in the one or more first images.

4. The electronic device of claim 2, wherein at least one of another tag distinct from the tag or a portion of meta information of other some second images having the non-visual commonality with the one or more first images among the plurality of second images correspond to at least one of another tag distinct from the tag or a portion of meta information of the one or more first images.

5. The electronic device of claim 1, comprising:
a camera,
wherein the instructions, when executed by the at least one processor individually or collectively, cause the electronic device to:
determine whether to assign the tag to a fourth image obtained through the camera based on a commonality between the one or more first images and the at least one third image.

6. The electronic device of claim 1, comprising:
a camera,
wherein the instructions, when executed by the at least one processor individually or collectively, cause the electronic device to:
identify a release of assignment of the tag with respect to at least one image among the at least one third image to which the tag is assigned and the one or more first images, and
determine whether to assign the tag to a fifth image obtained through the camera, based on a difference between the at least one image from which the tag is released and the one or more first images and the at least one third image to which the tag is assigned.

7. The electronic device of claim 1, wherein the instructions, when executed by the at least one processor individually or collectively, cause the electronic device to:
determine whether to assign the tag to an image based on a commonality between the one or more first images and remaining images excluding the third image among the plurality of second images.

8. The electronic device of claim 1, wherein the instructions, when executed by the at least one processor individually or collectively, cause the electronic device to:
based on the user input, generate a prompt; and
by performing the prompt based on an artificial intelligence (AI) model, identify the one or more first images.

9. The electronic device of claim 1,
wherein a part of the plurality of second images is displayed in a first area for a first category of the display,
wherein another part of the plurality of second images is displayed in a second area for a second category distinct from the first category of the display,
wherein the first area includes a text object representing the first category, and
wherein the second area includes another text object representing the second category.

10. A method performed by an electronic device comprising a display, the method comprising:
identifying, by the electronic device, one or more first images for assigning a tag defined by a user input;
based on a characteristic of the one or more first images, displaying, by the electronic device through the display, a plurality of second images among a plurality of images; and
assigning, by the electronic device, the tag to the one or more first images and at least one third image selected by another user input among the plurality of second images.

11. The method of claim 10, wherein some second images having a visual commonality with the one or more first images among the plurality of second images include a first object included in the one or more first images.

12. The method of claim 10, wherein another tag distinct from the tag, and/or a portion of meta information of other some second images having a non-visual commonality with the one or more first images among the plurality of second images correspond to another tag distinct from the tag, and/or a portion of meta information of the one or more first images.

13. The method of claim 10, comprising:
determining whether to assign the tag to a fourth image obtained through a camera, based on a commonality between the one or more first images and the at least one third image.

14. The method of claim 10, comprising:
identifying a release of assignment of the tag with respect to at least one image among the at least one third image to which the tag is assigned and the one or more first images; and
determining whether to assign the tag to a fifth image obtained through a camera, based on a difference between the at least one image from which the tag is released and the one or more first images and the at least one third image to which the tag is assigned.

15. One or more non-transitory computer readable storage media storing one or more computer programs including computer-executable instructions that, when executed by at least one processor comprising processing circuitry of an electronic device comprising a display, individually or collectively, cause the electronic device to perform operations, the operations comprising:
identifying, by the electronic device, one or more first images for assigning a tag defined by a user input;
based on a characteristic of the one or more first images, displaying, by the electronic device through the display, a plurality of second images among a plurality of images; and
assigning, by the electronic device, the tag to the one or more first images and at least one third image selected by another user input among the plurality of second images.

16. The one or more non-transitory computer readable storage media of claim 15, the operations comprising:
determining whether to assign the tag to a fourth image obtained through a camera based on a commonality between the one or more first images and the at least one third image.

17. The one or more non-transitory computer readable storage media of claim 15, the operations comprising:
identifying a release of assignment of the tag with respect to at least one image among the at least one third image to which the tag is assigned and the one or more first images; and
determining whether to assign the tag to a fifth image obtained through a camera, based on a difference between the at least one image from which the tag is released and the one or more first images and the at least one third image to which the tag is assigned.

18. The one or more non-transitory computer readable storage media of claim 15, the operations comprising:
determining whether to assign the tag to an image based on a commonality between the one or more first images and remaining images excluding the third image among the plurality of second images.

19. The one or more non-transitory computer readable storage media of claim 15, the operations comprising:
based on the user input, generating a prompt; and
by performing the prompt based on an artificial intelligence (AI) model, identifying the one or more first images.

20. The one or more non-transitory computer readable storage media of claim 15,
wherein a part of the plurality of second images is displayed in a first area for a first category of the display,
wherein another part of the plurality of second images is displayed in a second area for a second category distinct from the first category of the display,
wherein the first area includes a text object representing the first category, and
wherein the second area includes another text object representing the second category.
